(19) United States
(12) Patent Application Publication
(10) Pub. No.: US 2002/0194370 A1
(43) Pub. Date: Dec. 19, 2002

(54) Reliable links for high performance network protocols

(76) Inventor: Brendan Alexander Voge, Granite Bay, CA (US)

Correspondence Address: HEWLETT-PACKARD COMPANY, Intellectual Property Administration, P.O. Box 272400, Fort Collins, CO, 80527-2400, US

(21) Appl. No.: 09/849,171

(22) Filed: May 4, 2001

(51) Int. Cl. G06F 15/173

(52) U.S. Cl. 709/239; 709/224

(57) ABSTRACT

A method and system to implement a network of processors by using available links between processors of a multiprocessor system. One embodiment of the invention involves a method to operate a network, implemented on a multiprocessor system including a plurality of links to connect a plurality of processor cells, wherein the network can use the links to perform network operations. A second embodiment of the invention involves a network, implemented on a multiprocessor system including a plurality of links to connect a plurality of processor cells, wherein the network can use the links to perform network operations.

### BACKGROUND OF THE INVENTION

1. Field of the Invention

This invention relates generally to improving the network performance of multiple processor systems and increasing the flexibility of system usage, and more particularly to improving the network performance of multiple processor systems that already use high bandwidth links between individual processor modules configured in a multiprocessor system and increasing the flexibility of system usage for either a big multiprocessor system or several smaller machines.

2. Description of the Prior Art

In many data processing systems (e.g., computer systems, programmable electronic systems, telecommunication switching systems, control systems, and so forth) multiprocessor configurations are used. Such multiprocessor (MP) configurations comprise multiple processor modules (frequently referred to as processor cells). One common multiprocessor configuration is called a symmetric multiprocessor (SMP) system. Other common multiprocessor configurations include non-symmetric multiprocessor (non-SMP) systems. A MP system can have a number of processor cells configured as a network of smaller systems communicating to each other in a local area network (LAN) via one of several network protocols, for example, the widely known Ethernet (TCP/IP) network protocol (i.e., an Ethernet LAN).

The network protocol known as the Transmission Control Protocol (TCP) is involved in the ordering and delivery of data over the network (e.g., the transport layer of a stack for network packets). The Internet Protocol (IP) is involved in the actual network routing of packets. There are several other network protocols, but TCP is the most common network protocol in use at the beginning of the Twenty-First Century. Many network protocols are in fact based on a platform of TCP/IP.

An Ethernet LAN is one common type of LAN that can be implemented with relatively low cost standard hardware and software. In an Ethernet LAN, a processor cell typically includes an Ethernet LAN card in the input/output (I/O) subsystem that provides the actual interconnection to the other processor cells in the LAN. However, an Ethernet LAN card provides relatively much less bandwidth than is available through the high bandwidth, low latency links. Furthermore, the implementation of the Ethernet LAN protocol utilizes a significant amount of the processor resource inside each processor cell, decreasing the performance of each processor cell and the network.

The most obvious conventional way to obtain improved network performance is to design, fabricate, and incorporate additional high-bandwidth interconnection hardware in the network of smaller systems to provide a faster interconnection between the processor cells and thereby improve the overall performance of the network. The addition of high-bandwidth hardware to the network potentially eliminates the need for a significant revision of the operating system and application software running on the network. However, the design, fabrication, incorporation, and debug of such hardware are typically very time-consuming and expensive activities, and may not even achieve significant improvement in overall network performance.

An alternative conventional solution is to customize the application software to more effectively utilize the hardware already available in the network. The modification of the application software is potentially easier to implement than a modification in the hardware of the network. However, the customization of application software is still an expensive, difficult, and labor-intensive process. The possibility of a mistake in the software customization resulting in operational failure of the network is substantial. Even in a perfectly implemented customization of application software, the customization process is very time consuming and expensive.

It would be desirable to improve the performance of a network by utilizing already existing link hardware in a multiprocessor system to implement some network interconnection without customizing the network application software. What is needed is a method and system to utilize existing link hardware in a multiprocessor system to increase network performance while keeping the links transparent to the network application software.

### SUMMARY OF THE INVENTION

The present invention provides a method and system to utilize existing link hardware in a multiprocessor system to increase network performance while keeping the links transparent to the network application software.

A first aspect of the invention is directed to a method for operating a network connecting a plurality of processor cells that are already configured in a multiprocessor system with a plurality of links. The method includes recognizing by software operating on at least one processor cell when a network operation can use a link to implement a network operation, and utilizing the link to perform the network operation.

A second aspect of the invention is directed to a network to perform a plurality of network operations, implemented on a multiprocessor system including a plurality of links to connect a plurality of processor cells. The network includes a first module to recognize when a link provides sufficient bandwidth to perform a network operation, and a second module to utilize the link to perform the network operation.

These and other objects and advantages of the invention will become apparent to those skilled in the art from the following detailed description of the invention and the accompanying drawings.

### BRIEF DESCRIPTION OF THE DRAWINGS

FIG. 1 illustrates a conventional processor cell that is used in a multiprocessor.

FIG. 2 illustrates a multiprocessor (MP) system that comprises four processor cells connected together via high bandwidth links in which one embodiment of the invention can be applied.

FIG. 3 illustrates a MP system that includes a crossbar for the interconnection of the processor cells, to which another embodiment of the invention can be applied.

FIG. 4 illustrates a multiprocessor system with four processor cells interconnected in a “ring” configuration, to which another embodiment of the invention can be applied.

FIG. 5 illustrates a multiprocessor system with eight processor cells interconnected in a “mesh” configuration, to which another embodiment of the invention can be applied.

FIG. 6 illustrates one example of a conventional LAN comprising several stand-alone systems (SAS) interconnected by an Ethernet LAN.

FIG. 7 shows one flow chart for a method to use existing links in a multiprocessor with multiple processor cells in accordance with one embodiment of the present invention.

FIG. 8 shows a flow chart for a method to use existing links in a multiprocessor with multiple processor cells to implement a network in accordance with another embodiment of the present invention.

### DETAILED DESCRIPTION OF PREFERRED EMBODIMENTS OF THE INVENTION

The present invention provides method and system to improve network performance by using existing hardware links between processors in a multiprocessor (MP) system that are transparent to the execution of application software. Embodiments of the invention can be applied to multiprocessor systems (MP) comprising multiple processor modules (also called processor cells). One embodiment of the invention can be applied to symmetric multiprocessor systems (SMP). Another embodiment of the invention can be applied to non-symmetric multiprocessor systems (non-SMP).

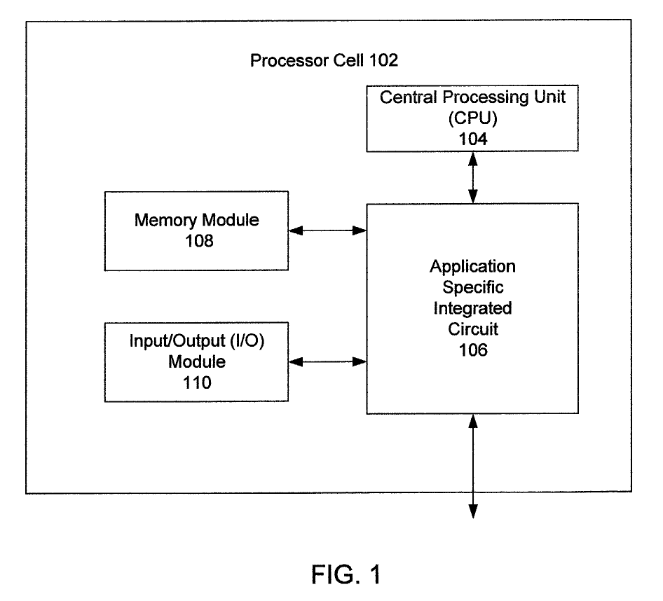

FIG. 1 illustrates a conventional processor cell 102 that can be used in a multiprocessor. Processor cell 102 comprises a central processor unit (CPU) 104, an application specific integrated circuit (ASIC) 106, a memory module 108, and an input/output (I/O) module 110. External data and instructions are received and transmitted via ASIC 106, and the data and instructions are received and transmitted by CPU 104, memory module 108, and I/O module 110. Processor cell 102 has sufficient resources to be a stand-alone system (since it has the three basic components CPU 104, memory module 108, and I/O module 110).

In a MP system, processor cells communicate to each other with high bandwidth, low latency links. Such high bandwidth, low latency links typically carry memory requests and responses between the processor cells with a protocol, which supports a coherent, shared memory model. However, the links between the processor cells could also be used as high bandwidth, low latency hardware communication paths between independent systems composed of the processor cells. Because of the very reliable hardware communication paths provided by these links, much of the network protocol (e.g., the Ethernet (TCP/IP) protocol, or other network protocols) currently implemented in software or implemented in specialized network cards (e.g., Ethernet I/O cards, or other types of network cards) could be accomplished using the existing links.

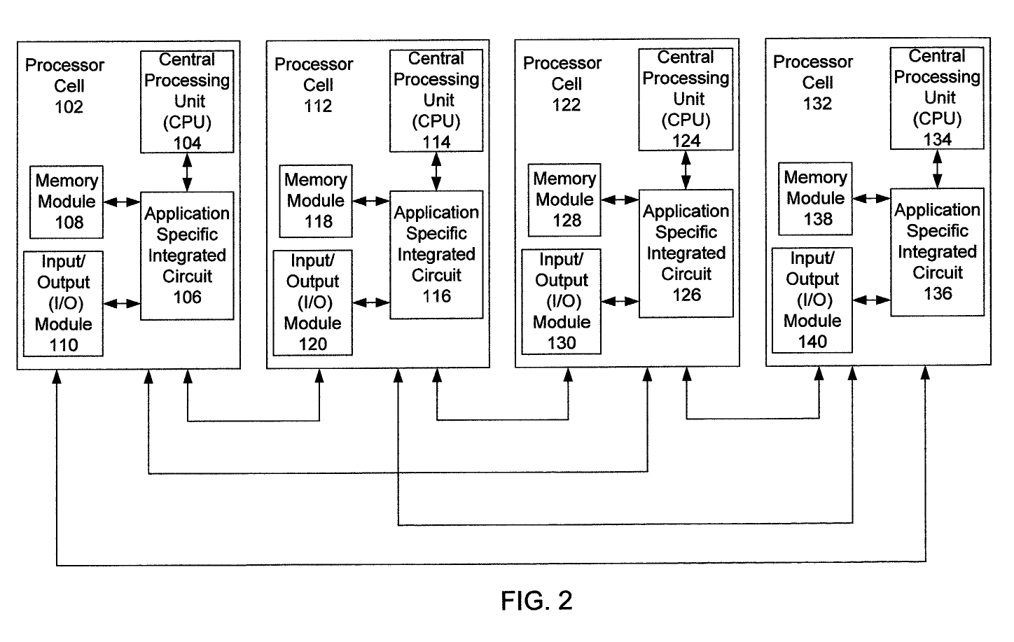

FIG. 2 illustrates a MP system that comprises four processor cells 102, 112, 122, and 132 connected together via high bandwidth links in which one embodiment of the invention can be applied. Processor cell 102 comprises a CPU 104, an ASIC 106, a memory module 108, and an I/O module 110. Processor cell 112 comprises a CPU 114, an ASIC 116, a memory module 118, and an I/O module 120. Processor cell 122 comprises a CPU 124, an ASIC 126, a memory module 128, and an I/O module 130. Processor cell 132 comprises CPU 134, an ASIC 136, a memory module 138, and an I/O module 140. The embodiment shown in FIG. 2 fully interconnects the processor cells 102, 112, 122, and 132 by interconnecting ASIC 106, ASIC 116, ASIC 126, and ASIC 136. In alternative embodiments of the invention, other high bandwidth integrated circuits (e.g., custom designed integrated circuits, standard cell integrated circuits, programmable logic integrated circuits and so forth) can be used instead of an ASIC. Several types of multiprocessor interconnections between the processor cells are possible, including cross-bars, meshes, rings, and other types of multiprocessor interconnection schemes.

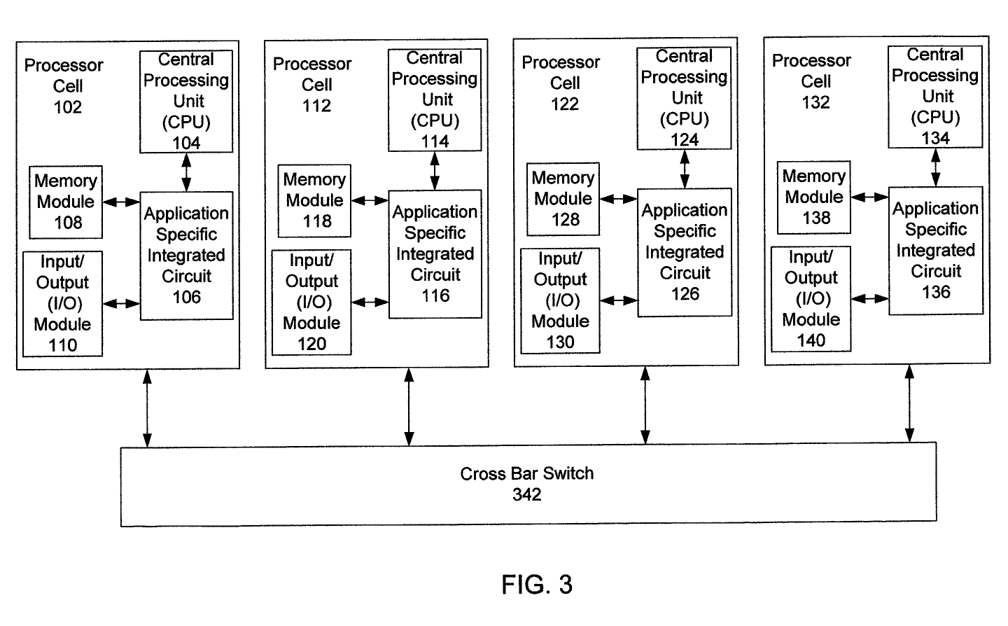

FIG. 3 illustrates a MP system that includes a crossbar 342 for the interconnection of the processor cells 102, 112, 122, and 132 to which another embodiment of the invention can be applied. The contents of the processor cells 102, 112, 122, and 132 were previously discussed in FIG. 2 above. Crossbar 342 would typically be implemented in a fast logic switching technology, and crossbar 342 fully interconnects the processor cells 102, 112, 122, and 132 by interconnecting ASIC 106, ASIC 116, ASIC 126, and ASIC 136.

The sharing of a link using the MP system shown in FIG. 3 can be illustrated by an example. Processor cells 102 and 112 can be used together as one (larger) MP system. Processor cells 122 and 132 each can be an independent stand-alone-system (SAS). Links for 102 and 112 can be used for MP coherent requests between processor cells 102 and 112; and simultaneously used for network communication (and network operations) between the MP system (processor cells 102 and 112) and the SAS's (processor cells 122 and 132).

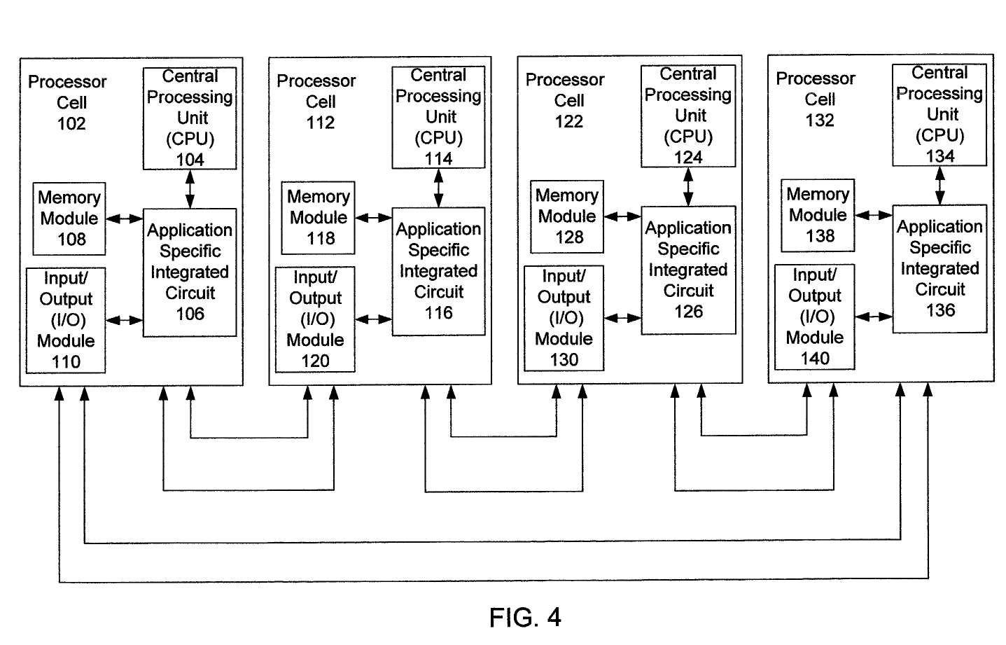

FIG. 4 illustrates a multiprocessor system with four processor cells 102, 112, 122, and 132 interconnected in a “ring” configuration, to which another embodiment of the invention can be applied. The extra processor cell links can be left unconnected, or used as additional ring interconnections (as shown). This multiprocessor system is optimized for cost, due to the passive nature of the back plane (e.g., wires on a printed circuit board or cables). This multiprocessor system is also optimized for expandability, since more processor cells can be inserted on the ring. However, this multiprocessor configuration sacrifices network performance, since each additional processor cell adds latency (i.e., this multiprocessor configuration adds an additional link or “hop” for every processor cell added), and each hop consumes some of the bandwidth of the ring interconnect.

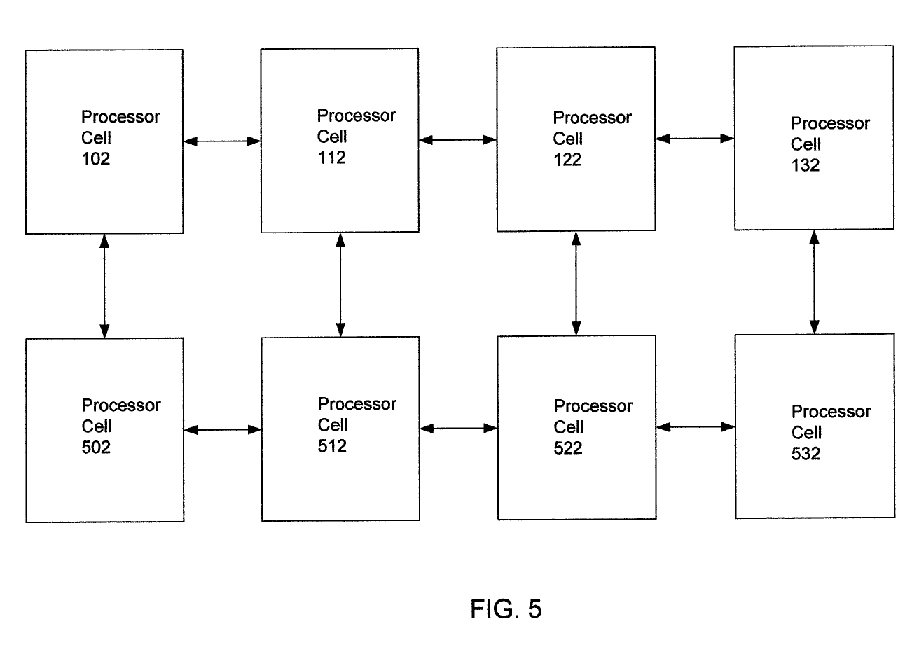

FIG. 5 illustrates a multiprocessor system with eight processor cells 102, 112, 122, 132, 502, 512, 522, and 532 interconnected in a “mesh” configuration, to which another embodiment of the invention can be applied. This multiprocessor system is optimized for network expandability and network performance in a cost-efficient multiprocessor configuration. The back plane in this multiprocessor system includes the interconnect wires. For clarity, the back plane outline for this multiprocessor configuration is omitted.

Both the multiprocessor system configuration of FIG. 2 and the multiprocessor system configuration shown in FIG. 3 illustrate two examples of multiprocessor system configurations to which embodiments of the invention can be applied. These configurations were directed to MP systems using four processor cells. However, alternative embodiments of the invention can be applied to other types of multiprocessor configurations using a greater or lesser number of processor cells. As discussed above, several types of multiprocessor interconnections between the processor cells are possible, including cross-bars, meshes, rings, and other types of multiprocessor interconnection schemes. Different types of multiprocessor system configurations (e.g., SMP systems, and non-SMP systems) can be used to provide the links that can be used by other embodiments of the invention.

More preferred embodiments of the invention include special hardware in the multiprocessor system to ensure that any errors caused by network traffic traveling over a link do not cause other network traffic to have problems. This special hardware can be implemented in the application specific integrated circuit 106 shown in FIGS. 1, 2, and 3, or it can be implemented in other types of custom integrated circuits, standard cell integrated circuits, programmable logic integrated circuits and so forth. This special hardware would provide enhanced system availability, by reducing the likelihood of a multiprocessor system machine crash due to excessive network traffic while sharing the links. However, other embodiments of the invention can provide a satisfactory functionality without including such special hardware.

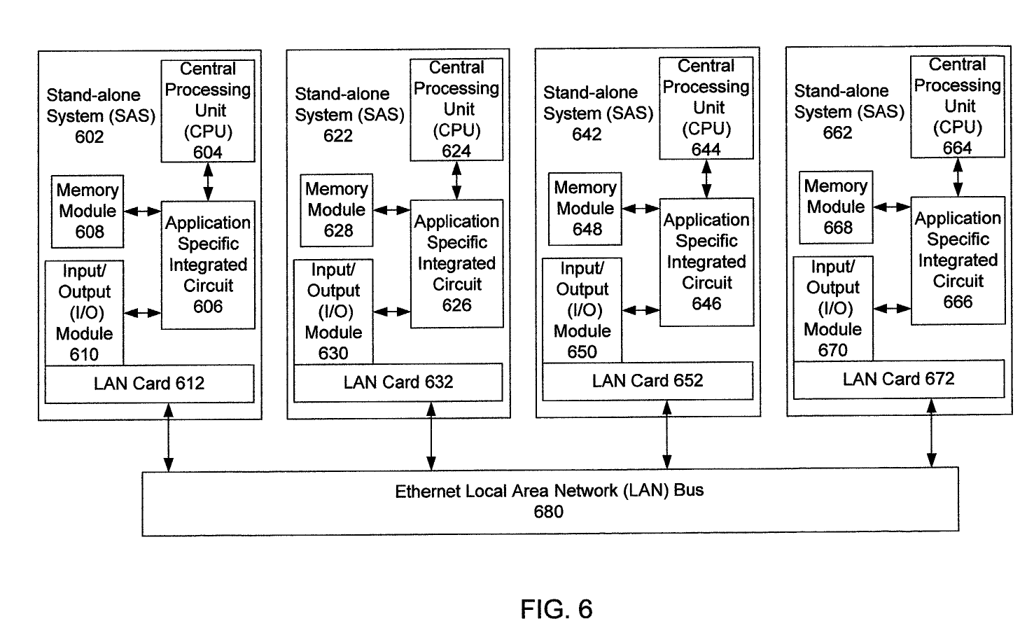

FIG. 6 illustrates one example of a conventional LAN comprising several stand-alone systems (SAS) 602, 622, 642, and 662 interconnected by an Ethernet LAN bus 680. Stand-alone system 602 comprises a CPU 604, an ASIC 606, a memory module 608, and an I/O module 610 that also includes a LAN card 612. Stand-alone system 622 comprises a CPU 624, an ASIC 626, a memory module 628, and an I/O module 630 that also includes a LAN card 632. Stand-alone system 642 comprises a CPU 644, an ASIC 646, a memory module 648, and an I/O module 650 that also includes a LAN card 652. Stand-alone system 662 comprises a CPU 664, an ASIC 666, a memory module 668, and an I/O module 670 that also includes a LAN card 672. Ethernet LAN bus 680 connects each of the stand-alone systems 602, 622, 642, and 662 via the LAN cards 612, 632, 652, and 672, respectively, in the I/O sub-systems 610, 630, 650, and 670, respectively. Therefore, this Ethernet LAN typically provides a much lower bandwidth connection compared to the bandwidth of the links within the MP system.

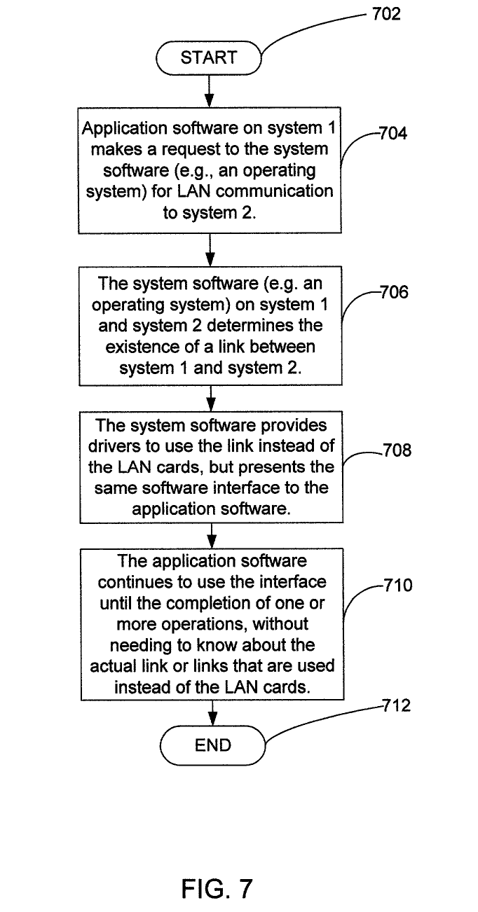

FIG. 7 shows one flow chart 700 for a method to use existing links in a multiprocessor with multiple processor cells to implement a network in accordance with one embodiment of the present invention. The method starts in operation 702, and is followed by operation 704. In operation 704, application software on system 1 makes a request to the system software (e.g., an operating system, or specialized system software) for LAN communication to system 2. In operation 706, the system software (e.g. an operating system, or specialized system software) on system 1 and system 2 determines the existence of a link between system 1 and system 2. The system software preferably also determines when the performance of the application software can be improved by using a link between two or more processor cells instead of a conventional network interconnection. In operation 708, the system software provides drivers to use the link instead of the LAN cards, but presents the same software interface to the application software. In operation 710, the application software continues to use the interface until the completion of one or more operations, without needing to know about the actual link or links that are used instead of the LAN cards. Operation 712 is the end of the method.

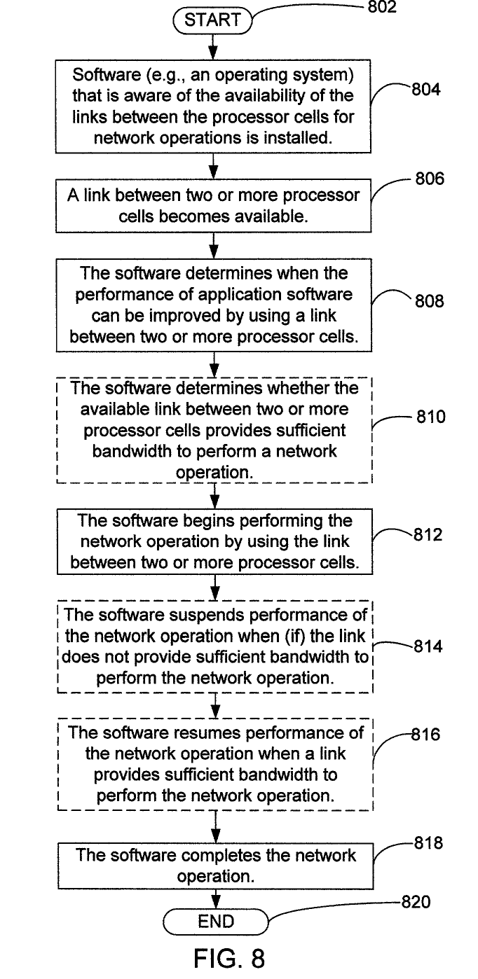

FIG. 8 shows a flow chart 800 for a method to use existing links in a multiprocessor with multiple processor cells to implement a network in accordance with another embodiment of the present invention. The method starts in operation 802, and is followed by operation 804. In operation 804, system software (e.g., an operating system, specialized system software, custom software, or an equivalent) that is aware of the availability of the links between the processor cells and the topology of the multiprocessor is installed on at least one processor cell. In operation 806, a link between two or more processor cells becomes available. In operation 808, the software determines when the performance of a network operation (e.g., execution of an instruction of an application software package) can be improved by using the available link. In optional operation 810, the software determines whether the available link provides sufficient bandwidth to perform a network operation. The link can be shared among multiple logical channels (e.g., one physical link with many logical channels). In operation 812, the software utilizes the link to perform the network operation. In optional operation 814, the software suspends performance of the network operation using the link when (and if) the link does not provide sufficient bandwidth to perform the network operation. In optional operation 816, the software resumes performance of the network operation when a link (either the original link or another link) provides sufficient bandwidth to perform the network operation. In operation 818, the software completes the operation. Operation 820 is the end of the method.

There are many similarities between the hardware contained in a processor cell and the hardware contained in a stand-alone system, as can be seen by comparing the processor cell 102 in FIG. 1 to the stand-alone system 402 in FIG. 4. Both a processor cell and a stand-alone system provide a general purpose CPU, memory, I/O, and some method to interconnect them (shown in FIG. 4 as a generic ASIC). For a MP system processor cell, the interconnection ASIC has special hardware to provide the high bandwidth link. For the stand-alone system, a LAN card in the I/O sub-system provides the Ethernet connection between systems. The LAN interconnection usually implements part of the network functionality by using the general purpose CPU of each processor to perform several computational tasks (e.g., packetization, addition of packet headers, computing and checking checksums, and packet re-assembly). Unfortunately, this can reduce the availability of the CPU for actual task operations.

The high bandwidth shared memory links used in a MP system share many attributes with an Ethernet LAN. Both types of interconnections provide the long streams of data that are divided into smaller units (packets). Both types of interconnections virtually guarantee the error-free delivery of all transmitted packets. Both types of interconnections preserve the order of all transmitted packets so that the original data stream can be re-constructed.

There are also significant differences between a LAN and a MP system using high bandwidth shared memory links between the processor cells in the MP system. Some major high-level differences are summarized in Table 1 below:

TABLE 1
Summary of High-Level Differences Between a LAN and a MP System

| ATTRIBUTE | LAN | LINK |
|---|---|---|
| Packetization | Long streams of bits are | Long streams of bits are |
| | divided into packets by | divided into cache lines by |
| | software or by dedicated | link hardware |
| | LAN hardware | |
| Packet headers | Packet headers are added | Packet headers are added |
| | by software or added by | by link hardware |
| | dedicated LAN hardware | |
| Guaranteed | There is a “handshake” | Link error rates are |
| delivery of | protocol used between | sufficiently low that |
| packets | sender and receiver to | guaranteed delivery is |
| | ensure that all the packets | ensured, or a re-transmit is |
| | get delivered. | implemented in hardware |
| Guarantee of | A checksum is computed | A link provides error |
| no errors in | by the sender and checked | correction code (ECC) in |
| transmitted | by the receiver, either by | the link hardware for error |
| data | software or by dedicated | detection and correction. |
| | LAN hardware | |
| Guarantee of | Packet sequence numbers | A link always preserves the |
| the order of | are added by software or | ordering of the packets due |
| the packets | added by dedicated LAN | the hardware |
| | hardware to the packet | implementation. |
| | header to allow correct re- | |
| | assembly in order | |
| Bandwidth | 1 Gigabits/sec with 10 | 32 Gigabits/sec with 80 |
| provided | Gigabits/sec expected in | Gigabits/sec expected in |
| | the future | the future |

The TCP/IP Ethernet protocol is sometimes described as a layered stack. Each layer in the stack handles specific functionality necessary to provide the functionality described above. Each layer in the stack is summarized below in Table 2 (with the higher layers lumped together):

TABLE 2
Summary of the TCP/IP Ethernet Protocol Layered Stack

| LAYER | FUNCTIONALITY |
|---|---|
| Physical | Send raw bits between sender and receiver |
| Data link | Guarantee the error-free delivery of raw bits |
| | (e.g., by using a checksum) |
| Network | Route packets to the correct destination |
| Transport | Convert data streams to packets and guarantee |
| | the packet ordering |
| Session, Presentation | Establish a connection between the application |
| and Application | software on different machines |

In one embodiment, the physical layer is implemented in hardware for both link-based systems and Ethernet LANs. The Data link, Network, and Transport layers for an Ethernet LAN system are either implemented in software, or implemented in dedicated LAN hardware. However, for the link-based system the Data link, Network, and Transport layers are implemented in the existing link hardware. This type of implementation allows a higher network performance and a reduced network cost, assuming the links are already present.

Keeping the Same Application Software

In preferred embodiments of the invention, the usage of already existing high bandwidth multiprocessor links to implement LAN connections between processor cells would be kept transparent to the application software. Application software transparency offers a significant advantage, since existing application software would not require any modifications to take advantage of the high bandwidth links. Application software transparency can be implemented by designing the operating system software to be aware of the option of using the high bandwidth links whenever possible. Application software transparency also requires that the operating system software understand the topology of the multiprocessor system, and that the operating system only establish a LAN-based connection if a high bandwidth link does not already exist. Due to the large number of application software packages and the limited number of operating systems, application software transparency is a very significant advantage.

Embodiments of the invention recognize when a link is capable of providing sufficient bandwidth to perform a network operation, and determine when a link does not provide sufficient bandwidth to perform the network operation. Embodiments of the invention will preferably also be able to choose either another link or a conventional network interconnection to perform a network operation when a link does not provide sufficient bandwidth to perform the network operation. Embodiments of the invention will also preferably be able to suspend and resume performance of a network operation when a link temporarily does not provide sufficient bandwidth to perform the network operation. Embodiments of the invention will also preferably be able to suspend a network operation when a first link does not provide sufficient bandwidth to perform the network operation, and resume performance of the network operation on a second link.

Embodiments of the invention that use existing links in a multiprocessor system to implement a LAN interconnection offer several significant advantages. One advantage is the flexible usage of the multiprocessor hardware without incurring additional hardware cost. The multiprocessor system can be used either as one large system, used as several smaller systems, or used as a mix of large and small systems. Since the links between the processor cells already exist, there is no additional hardware cost necessary to support this flexibility.

Another advantage is the additional network performance gained due to the off-loading of work previously done in software. Typical LAN implementations normally require each processor module CPU to do significant work in implementing the TCP/IP protocol, whereas preferred embodiments of the invention use existing link hardware to accomplish these TCP/IP protocol functions.

Still another advantage is from the additional network performance gained by the use of very high bandwidth links versus a conventional LAN connection. Conventional LAN speeds are 1 Gigabits/sec, compared with link technology that already offers 32 Gigabits/sec. Preferred embodiments of the invention gain all the previously discussed advantages in network performance and flexibility, and do not require that any application software be re-written, or even be aware of the underlying hardware differences.

The exemplary embodiments described herein are for purposes of illustration and are not intended to be limiting. Therefore, those skilled in the art will recognize that other embodiments could be practiced without departing from the scope and spirit of the claims set forth below.

What is claimed is:

1. A method for operating a network connecting a plurality of processor cells that are already configured in a multiprocessor system with a plurality of links, comprising:
recognizing by software operating on at least one processor cell when a network operation can use a link of said plurality of links to implement a network operation; and
utilizing said link of said plurality of links to perform said network operation.

2. The method of claim 1, wherein said multiprocessor system is a symmetric multiprocessor system.

3. The method of claim 1, wherein said software is an operating system.

4. The method of claim 1, wherein said network is an Ethernet local area network.

5. The method of claim 1, wherein said multiprocessor system includes at least two processor cells interconnected in a configuration chosen from a group of configurations consisting of: a fully interconnected configuration, a cross-bar configuration, a mesh configuration, or a ring configuration.

6. The method of claim 5, wherein said step of recognizing comprises:
determining whether said link provides sufficient bandwidth to complete said network operation.

7. The method of claim 5, wherein said step of recognizing comprises:
choosing a second link from said plurality of links when a first link of said plurality of links does not provide sufficient bandwidth to perform said network operation.

8. The method of claim 1, wherein said step of utilizing comprises:
suspending said network operation when said link of said plurality of links is not providing sufficient bandwidth to perform said network operation; and
resuming said network operation when said link of said plurality of links provides sufficient bandwidth to perform said network operation.

9. The method of claim 1, further comprising:
suspending said network operation when said link of said plurality of links is not providing sufficient bandwidth to perform said network operation; and
performing said network operation on a second link of said plurality of links when said link is not providing sufficient bandwidth to perform said network operation.

10. A method for operating a network connecting a plurality of processor cells that are already configured in a multiprocessor system with a plurality of links, comprising:
installing software on at least one processor cell of said plurality of processor cells, wherein said software is aware of said plurality of links between said plurality of processor cells;
recognizing by said software when a network operation can use a link of said plurality of links to implement a network operation; and
utilizing said link of said plurality of links to perform said network operation.

11. The method of claim 10, wherein said multiprocessor system is a symmetric multiprocessor system.

12. The method of claim 10, wherein said software is an operating system.

13. The method of claim 10, wherein said network is an Ethernet local area network (LAN).

14. The method of claim 10, wherein said multiprocessor system includes at least two processor cells interconnected in a configuration chosen from a group of configurations consisting of: a fully interconnected configuration, a cross-bar configuration, a mesh configuration, or a ring configuration.

15. The method of claim 14, wherein said step of recognizing comprises:
determining whether said link provides sufficient bandwidth to perform said network operation.

16. The method of claim 14, wherein said step of recognizing comprises:
choosing a second link from said plurality of links when a first link of said plurality of links does not provide sufficient bandwidth to perform said network operation.

17. The method of claim 10, wherein said step of utilizing comprises:
suspending said network operation when said link of said plurality of links is not providing sufficient bandwidth; and
resuming said network operation when said link of said plurality of links provides sufficient bandwidth to perform said network operation.

18. The method of claim 10, further comprising:
suspending said network operation when said link of said plurality of links is not providing sufficient bandwidth; and
performing said network operation on a second link of said plurality of links when said link is not providing sufficient bandwidth to perform said network operation.

19. A network to perform a plurality of network operations, implemented on a multiprocessor system including a plurality of links to connect a plurality of processor cells, said network comprising:
a first module to recognize when a link of said plurality of links provides sufficient bandwidth to perform a network operation of said plurality of network operations; and
a second module to utilize said link to perform said network operation of said plurality of network operations.

20. The network of claim 19, wherein said multiprocessor system is a symmetric multiprocessor system.

21. The network of claim 19, wherein said network is an Ethernet LAN.

22. The network of claim 19, wherein said first module and said second module are implemented in an operating system.

23. The network of claim 22, wherein said operating system is installed on at least one processor cell of said plurality of processor cells.

24. The network of claim 19, wherein said multiprocessor system includes at least two processor cells interconnected in a configuration chosen from a group of configurations consisting of: a fully interconnected configuration, a cross-bar configuration, a mesh configuration, or a ring configuration.

25. The network of claim 19, wherein said first module comprises:
software to determine whether said link provides sufficient bandwidth to perform said network operation.

26. The network of claim 19, wherein said first module comprises:
software to choose a second link from said plurality of links when a first link of said plurality of links does not provide sufficient bandwidth to perform said network operation.

27. The network of claim 19, wherein said second module comprises:
software to suspend said network operation when said link of said plurality of links is not providing sufficient bandwidth; and
software to resume said network operation when said link of said plurality of links provides sufficient bandwidth to perform said network operation.

28. The network of claim 19, wherein said second module comprises:
software to suspend said network operation when said link of said plurality of links is not providing sufficient bandwidth; and
software to perform said network operation on a second link of said plurality of links when said link is not providing sufficient bandwidth to perform said network operation.
